(19) United States
(12) Patent Application Publication
(10) Pub. No.: US 2008/0086873 A1
(43) Pub. Date: Apr. 17, 2008

(54) Method and apparatus for mounting electronic part

(75) Inventors: Masaru Saitou, Tokyo (JP); Takeshi Mizuno, Tokyo (JP)

Correspondence Address: DRINKER BIDDLE & REATH (DC), 1500 K STREET, N.W., SUITE 1100, WASHINGTON, DC, 20005-1209, US

(73) Assignee: JUKI CORPORATION

(21) Appl. No.: 11/907,262

(22) Filed: Oct. 10, 2007

(30) Foreign Application Priority Data
Oct. 11, 2006 (JP) P.2006-277079

(51) Int. Cl. B23P 19/00

(52) U.S. Cl. 29/743; 29/739; 29/740; 29/832

(57) ABSTRACT

A method of mounting an electronic part includes, providing a liquid at a surface of the electronic part or a suction end of a suction nozzle, attaching the electronic part to a suction end of a suction nozzle via the liquid, suctioning the liquid from the suction end to hold the electronic part at the suction end, and mounting the electronic part onto a substrate. And an apparatus for mounting an electronic part includes a liquid supplier which provides a liquid on a surface of the electronic part, and a suction nozzle which suctions the liquid and holds the electronic part in which the suction nozzle mounts the electronic part onto a substrate.

The present invention claims priority from Japanese Patent Application No. 2006-277079, filed on Oct. 11, 2006, the entire content of which is incorporated herein by reference.

### BACKGROUND OF INVENTION

1. Field of the Invention

The present invention relates to method and apparatus for mounting an electronic part and, the invention relates to method and apparatus suitable for automatically mounting an electronic part onto a printed substrate or onto substrates of a liquid crystal panel, a display panel and the like.

2. Description of the Related Art

As a suction nozzle which is used to mount an electronic part, Japanese Patent No. 3607445 discloses a suction nozzle the front and longitudinal section view of which are shown in FIGS. 17 and 18 respectively.

This suction nozzle 70 is used mainly to suction an electronic part A such as a capacitor having a plane of a rectangular shape, while its nozzle forming surface 74 has a chamfered rectangular shape so as to match the shape of the electronic part A. Also, the suction nozzle 70 includes a main suction hole 73a formed in the central portion thereof as well as four secondary suction holes 73b respectively formed outside the main suction hole 73a. In order to correspond to the shape of the electronic part A, the four secondary suction holes 73b are disposed mutually symmetric with respect to vertical and horizontal lines to thereby provide a rectangular shape as a whole. Therefore, the flow rate distribution of the air in the plane direction, as shown in FIG. 19, becomes gradually slower toward the outside diameter direction from the center position of the nozzle forming surface 74, namely, the center of the main suction hole 73a (FIG. 19B). Lines, which are formed by connecting together the portions of the plane where the air flow rates are equal, provide a substantially rectangular shape (FIG. 19A).

Therefore, as shown in FIG. 17, when the electronic part A is supplied in such a manner that it is misaligned in the long side direction of the electronic part A with respect to the nozzle forming surface 74, the air flowing around the short side of the electronic part A on the right side in the drawing flows a long distance along the surface of the electronic part A until it reaches the nozzle holes 73. Accordingly, the air on the right side of the electronic part A is larger in the viscosity resistance than the air on the left side of the electronic part A, and thus the flow rate of the former is slower than that of the latter. That is, the flow of the air on the left side of the nozzle forming surface 74 is faster than that of the air on the right side, and according to the Bernoulli's law, the high speed side is lower in pressure than the low speed side, thereby generating a force with respect to the electronic part A which moves the electronic part A laterally to the left. This applies similarly to a case in which the electronic part A is supplied in such a manner that it is shifted in the short side direction thereof with respect to the nozzle forming surface 74.

Therefore, the electronic part A is suctioned in such a manner that, according to the flow of the air when it is suctioned, it is moved laterally toward the center of the nozzle forming surface 74. Especially, in such air flow rate distribution as shown in FIG. 19, since the flow rate of the air flowing along the surface of the electronic part A is fast as a whole, the speed reduction of the air due to the viscosity resistance thereof becomes large and thus the flow rate difference of the air due to the shifted position of the electronic part A becomes large. Thus, when the nozzle holes 73 are disposed in such a manner that the suction air may act on the entire area of the electronic part A to be suctioned, when suctioning the electronic part A, the position of the electronic part A may be automatically corrected.

In the suction nozzle disclosed Japanese Patent No. 3607445, when suctioning the electronic part using the two or more suction holes formed in the head portion of the suction nozzle, the electronic part moves during the time while it is floated up and is then contacted with the head of the suction nozzle. Specifically, in the case of a heavy electronic part, there is a possibility that there may not be obtained a sufficient horizontal direction force which is generated due to the difference between the flow rates of the suction air. That is, there is a possibility that the position of the electronic part may not be corrected automatically.

In the other case, a small-size electronic part has been employed recently. It is necessary to open up two or more holes in the head portion of the suction nozzle, in order to make the suction nozzle to correspond to such small-size electronic part. The diameter of the nozzle head portion must be ø 0.2 [mm] or less.

When the nozzle head portion diameter is ø 0.2 [mm] or less, the main suction hole 73a must be about ø 50 [μm], while the secondary suction holes must be about ø 25 [μm]. However, it is difficult to manufacture a part having such fine holes and thus, owing to the low yield of such part when manufactured and the increased working time thereof, the manufacture of such part results in the increased cost thereof.

Also, since the small hole diameter increases the possibility that the suction holes may be clogged with dust or the like, there is raised a problem that the occurrence of poor suction may increase.

### SUMMARY OF INVENTION

It is an objection of the invention to provide an electronic part mounting method and an apparatus which positively suctions and holds the center position of an electronic part ranging from a large-size one to a small-size one owing to the automatic suction position correction effect thereof and, after then, mounts the electronic part onto a substrate.

It is another object of the invention to simplify the working operation of the suction nozzle and to enhance the suction accuracy of the electronic part.

According a first aspect of the invention, a method of mounting an electronic part includes, providing a liquid on a surface of the electronic part, attaching the electronic part to a suction end of a suction nozzle via the liquid, suctioning the liquid from the suction end to hold the electronic part at the suction end, and mounting the electronic part onto a substrate.

According second and forth aspects of the invention, the liquid may be a pure water.

According a third aspect of the invention, a method of mounting an electronic part includes, providing a liquid at a suction end of a suction nozzle, attaching the electronic part to the suction end of the suction nozzle via the liquid, suctioning the liquid from the suction end to hold the electronic part at the suction end, and mounting the electronic part onto a substrate.

According a fifth aspect of the invention, an apparatus for mounting an electronic part includes a liquid supplier which provides a liquid on a surface of the electronic part, and a suction nozzle which suctions the liquid and holds the electronic part in which the suction nozzle mounts the electronic part onto a substrate.

According a sixth aspect of the invention, the liquid supplier may be provided on the suction nozzle.

According a seventh aspect of the invention, an air solenoid valve which controls the suction nozzle, and a liquid solenoid valve which controls an amount of the liquid to be provided from the liquid supplier.

According an eighth aspect of the invention, the liquid may be a pure water.

### BRIEF DESCRIPTION OF THE DRAWINGS

FIG. 1 is a perspective view of some portions of an electronic part mounting apparatus according to an embodiment of the invention,

FIG. 2 is a perspective view to show how a suction nozzle suctions an electronic part thereto.

FIG. 3 is a partial section view of a suction nozzle used in a first embodiment,

FIG. 4 is an explanatory view of an outline of a fluid control system used in the first embodiment,

FIGS. 5A and 5B are explanatory views showing relationships between a shape of a suction end portion of a suction nozzle and a liquid drop of pure water to be attached to the suction end portion,

FIG. 6 is an explanatory view of a first stage of the operation of the first embodiment,

FIG. 7 is an explanatory view of a second stage of the operation of the first embodiment,

FIG. 8 is an explanatory view of a third stage of the operation of the first embodiment,

FIG. 9 is an explanatory view of a fourth stage of the operation of the first embodiment,

FIG. 10 is an explanatory view of a fifth stage of the operation of the first embodiment,

FIG. 11 is a flow chart of the operation of the first embodiment,

FIG. 12 is a typical view to explain the self alignment effect of liquid,

FIG. 13 is an explanatory view showing a second embodiment of the invention,

FIG. 14 is another explanatory view showing the second embodiment,

FIG. 15 is an explanatory view showing a third embodiment according to the invention,

FIG. 16 is another explanatory view showing the third embodiment,

FIG. 17 is a side view of a conventional suction nozzle and an electronic part, showing how the electronic part is suctioned by the suction nozzle,

FIGS. 18A and 18B are a section views of a conventional suction nozzle, and

FIGS. 19A and 19B are explanatory views showing relationships between a bottom surface of a conventional suction nozzle and a flow rate of air.

### DETAILED DESCRIPTION

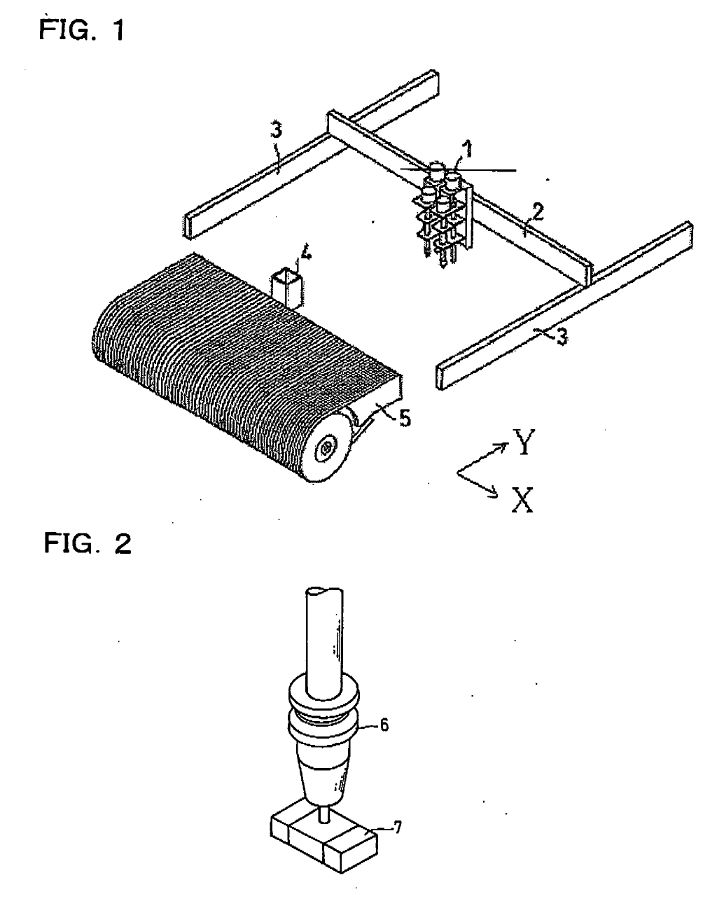

FIG. 1 is a perspective view of the main portions of an electronic part mounting apparatus according to an embodiment of the invention.

In FIG. 1, a mounting head 1, which suctions and holds an electronic part (hereinafter also referred to as a part) and mounts the electronic part, is mounted on an X axis gantry 2 which is movable in the X axis direction of the electronic part mounting apparatus. The mounting head 1 and the X axis gantry 2 are respectively mounted on a Y axis gantry 3 which is movable in the Y axis direction of the electronic part mounting apparatus.

Also, on the electronic part mounting apparatus, there is provided a part recognition device 4 which recognizes an attitude of a suctioned electronic part by using a CMOS camera or a CCD Camera. Further, on a front side portion of the electronic part mounting apparatus, there is provided apart supply device 5 which supplies an electronic part to be mounted on a substrate.

On a shaft head portion of the mounting head 1, as shown in FIG. 2, there is mounted a suction nozzle 6. Thus, after an electronic part 7 is suctioned and held on the head portion of the mounting head 1 using the suction nozzle 6, the electronic part 7 is mounted onto a substrate (not shown) which is previously positioned. Referring to the structure of the electronic part 7 shown in FIG. 2, the central portion thereof is a main body of the electronic part 7, whereas the two end portions thereof correspond to electrodes.

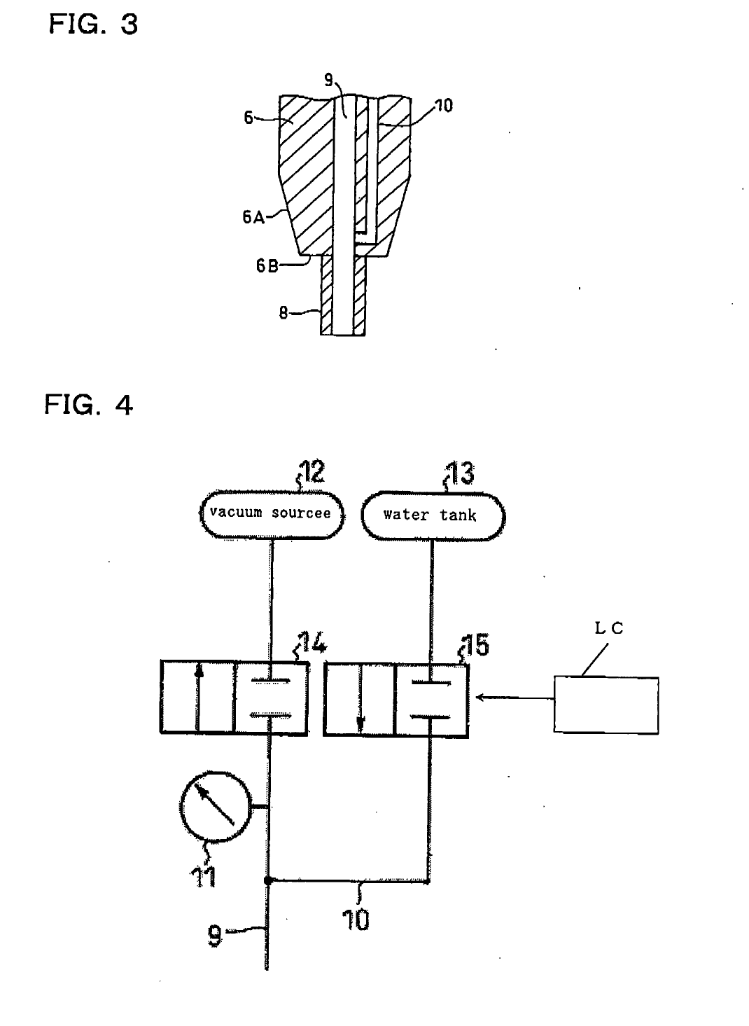

Next, description will be given below of the structure of the suction nozzle 6 used in the present embodiment with reference to FIG. 3 which is a partial section view of the suction nozzle 6.

A main body lower portion 6A of the suction nozzle 6 has a tapered shape which narrows as it goes toward the head thereof. To the lower end portion 6B of the main body lower portion 6A, there is connected a pipe-shaped nozzle head portion 8 in such a manner to form a stepped structure.

Inside the suction nozzle 6, an air suction hole 9 for vacuum suctioning a part is formed in such a manner that it penetrates through the suction nozzle 6 up to the suction end (head) of the nozzle head portion 8. A pipe 10 which is used to supply liquid such as pure water to the nozzle head is connected to an intermediate portion of the suction hole 9.

That is, the electronic part mounting apparatus according to the first embodiment includes a vacuum control system for making the suction hole 9 negative in pressure and a liquid control system for supplying pure water (liquid) to the pipe 10.

FIG. 4 shows a connecting system for the part suctioning air of the suction nozzle 6 and the pure water respectively used in the above two control systems.

The vacuum air suction hole 9 of the suction nozzle 6 is connected through a pressure gauge 11 and a suction air solenoid valve 14 to a vacuum source 12.

On the other hand, the pipe 10, which supplies pure water to the suction nozzle 6, is connected through a pure water solenoid valve 15 to a water tank 13 which is provided on the mounting head 1. The solenoid valve 15 may be controlled, that is, may be opened and closed by a liquid quantity control circuit LC, whereby the quantity of supply of pure water may be controlled such that the suction force of the suction nozzle 6 may be set to a given level.

Therefore, according to the first embodiment, a suction operation using the suction nozzle 6 may be carried out and also pure water may be supplied to the suction end (head) of the nozzle head portion 8.

Referring here to the structure of the nozzle head portion 8 of the suction nozzle 6 used in the first embodiment, the outer peripheral upper end thereof is connected to the nozzle lower end portion 6B at right angles, and the nozzle head portion 8 is made of a straight pipe having the same diameter up to the suction end thereof.

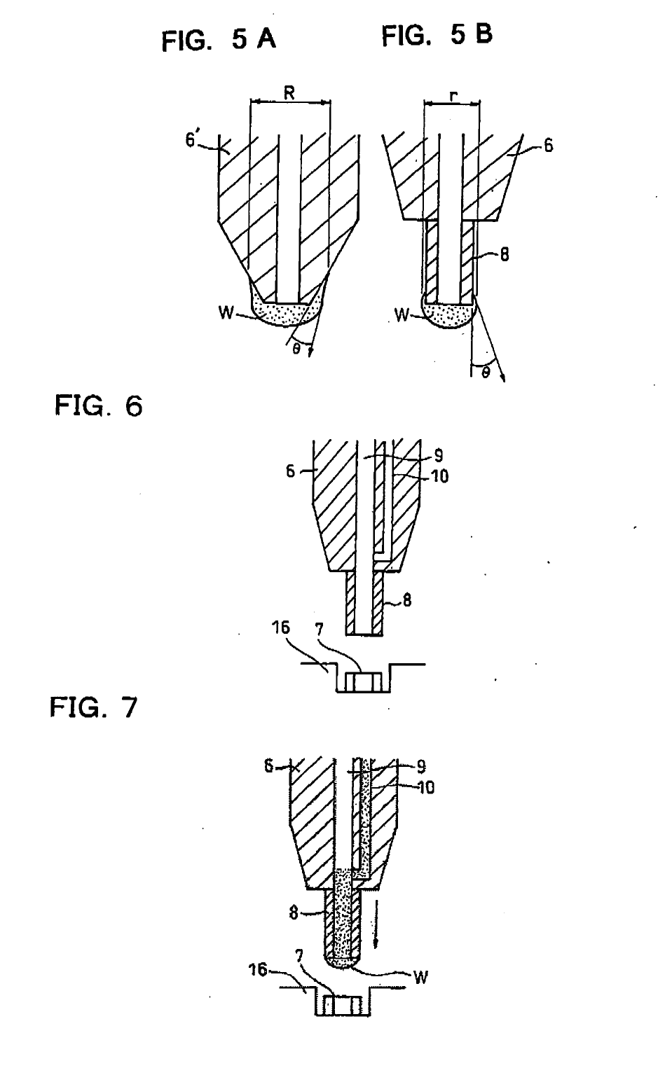

FIG. 5B shows a case where a liquid drop sticks to the suction end of the lower end portion of a straight pipe, while FIG. 5A shows a case where a liquid drop sticks to the suction end of a pipe having a tapered portion. In FIGS. 5A and 5B, suppose the contact angle of water is θ, in the case of a suction nozzle 6′ having such a tapered portion as shown in FIG. 5A, the diameter of a liquid drop W attached thereto provides R.

On the other hand, in the case of a suction nozzle 6 including such a nozzle head portion 8 that is connected perpendicularly to the suction nozzle 6 and is made of a straight pipe, assuming that the suction nozzle 6 and head portion 8 are made of the same material and the contact angles of liquid drops attached to them are the same or θ, when the straight pipe has no tapered portion, the diameter of the liquid drop attached thereto provides r. That is, the diameter of the liquid drop may be reduced.

When the outer periphery of the suction end is made in the form of a perpendicular surface as much as possible, the liquid drop is allowed to stick only to the suction end of the suction nozzle 6. This not only may reduce the quantity of liquid drops sticking to the suction nozzle as much as possible but also may prevent the liquid drop from sticking to other portions of the suction nozzle than the head portion thereof, which makes it possible to control the diameter (size) of the liquid drop accurately.

In the above-mentioned structure, description will be given below of the flow of an electronic part mounting operation according to the present embodiment.

In FIG. 1, the X axis gantry 2 and Y axis gantry 3 are operated to move the mounting head 1 upwardly of the part supply device 5 and allow the mounting head 1 to suction an electronic part (not shown) thereto.

The mounting head 1 with the electronic part stuck thereto is moved upwardly of the part recognition device 4, and, the part recognition device 4 is allowed to recognize the electronic part. After completion of this electronic part recognition, the mounting head 1 is moved to the portion of the substrate where the electronic part is to be mounted, where the mounting head 1 is allowed to mount the electronic part onto the part mounting portion of the substrate.

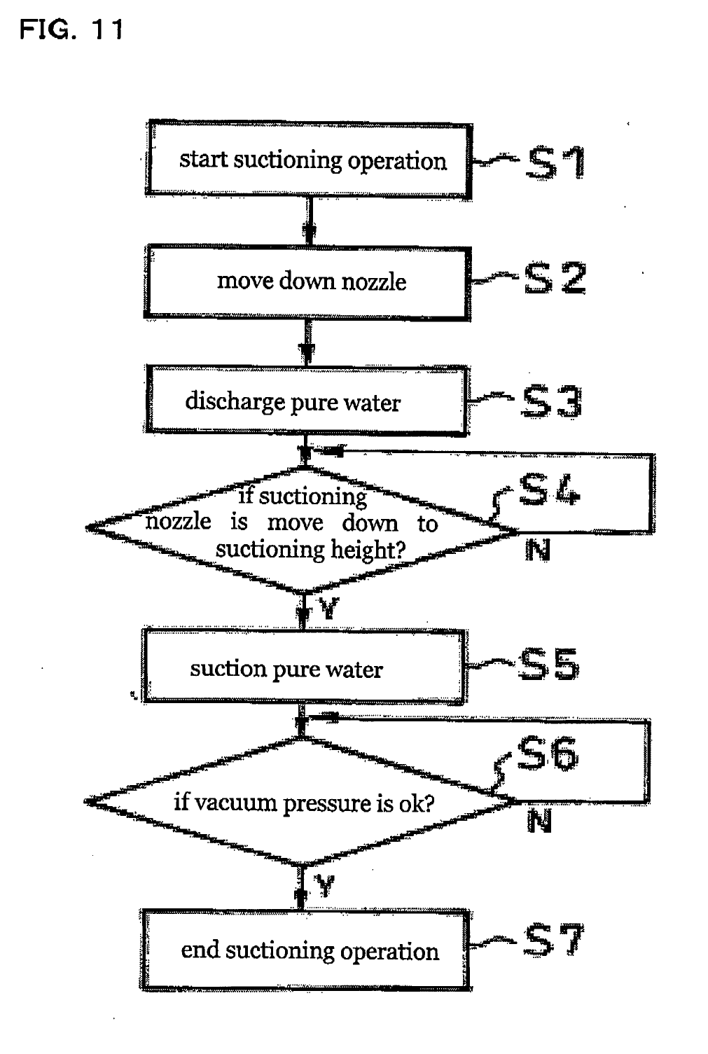

Description will be given below of the electronic part mounting operation with reference to FIGS. 6˜10 as well as according to a flow chart shown in FIG. 11.

At first, a part suction operation is started (Step 1), and the mounting head 1 is moved onto the upper surface of the part supply device 5. The mounting head 1, which is positioned on the part supply device 5, lowers the suction nozzle 6 for suctioning the electronic part 7 (Step 2).

FIG. 6 shows a state where the suction nozzle 6 approaches the electronic part 7 supplied to the part supply device 5 by a part supply tape 16 in this lowering operation.

In the present embodiment, while carrying out the above-mentioned lowering operation of the suction nozzle 6, the pure water solenoid valve 15 is opened, whereby the pure water W is discharged in a slight quantity and, as shown in FIG. 7, the pure water W is stored on the suction end of the nozzle head portion 8 (Step 3).

The suction nozzle 6 is lowered on down to a suction height where the pure water W stored on the head of the suction nozzle 6 and the surface (upper surface) to be suctioned of the electronic part 7 are contacted with each other (Step 4).

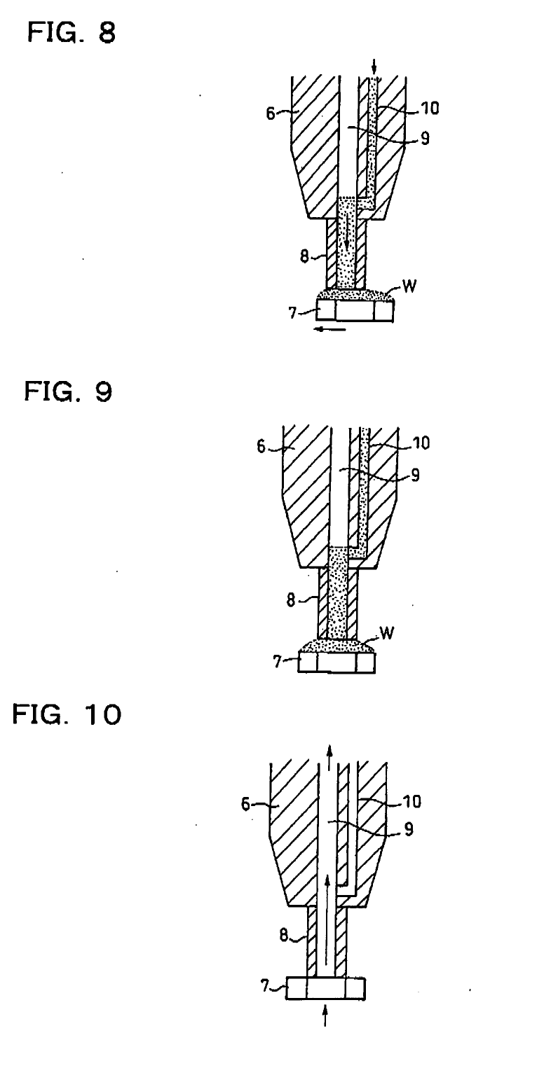

When the electronic part 7 is contacted with the pure water W, owing to the surface tension of the pure water W, the electronic part 7 is attracted and attached to the suction nozzle 6. Description will be given while using a figure in which the electronic part is different in size. In the suction operation, since the center of the suction nozzle 6 is shifted from the center position of the electronic part 7, the electronic part 7 may be suctioned in such a manner as shown in FIG. 8. However, even in this case, owing to the self alignment effect (automatic position correcting effect) based on the surface tension of the pure water W, the center position of the electronic part 7 is allowed to move to the center of the suction nozzle 6. This self alignment effect will be discussed later in detail.

Therefore, there is provided a state in which the center position of the electronic part 7 is naturally pulled closer to the center of the suction nozzle 6. After then, when the solenoid valve 15 is switched to thereby open the vacuum air solenoid valve 14, the pure water W stored in the suction hole 9 by the vacuum system is suctioned and removed therefrom, whereby, as shown in FIG. 10, the electronic part 7 is contacted with the suction nozzle 6 in such a manner that the center of the former is coincident with the center of the suction end of the latter, and thus the electronic part 7 may be properly suctioned to and held by the suction nozzle 6.

When a suction pressure shown by the pressure gauge 11 provided for a pipe of a vacuum system for the suction hole 9 is equal to or higher than a threshold value set for a pressure when suctioning an electronic part (Step 6), it is judged that the electronic part has been suctioned and held by the suction nozzle, and there is output a suction completion signal (Step 7), whereby the step goes to the moving operation of the mounting head 1 in the X and Y axis direction.

As described above, according to the present embodiment, there may be provided the following effects.

(1) Since the action of the surface tension of the liquid is used, there may be obtained a self alignment effect and, specifically, it is always possible to make the center of an electronic part and the center of a suction nozzle agree with each other. Therefore, the accuracy of the positioning of the electronic part when mounting it may be enhanced.

Description will be given of the self alignment effect. This is an effect that, when a suction nozzle is made to approach an electronic part in order to suction it, even if the center position of the suction nozzle is shifted from the center of the electronic part, the shifted position of the electronic part may be corrected automatically to the proper position thereof when the suction nozzle suctions the electronic part.

A liquid substance tends to become stable in such a manner that it minimizes its surface tension. In other words, since the largest number of molecules enter the inside of the liquid substance and are going to be surrounded by the largest number of adjacent molecules, the drop of the liquid substance is going to take a spherical form in which a ratio of its surface area to its volume is the smallest. An effect to minimize the surface area is referred to as the surface tension and this surface tension is a power or a force which appears in every interface (vapor phase-liquid phase interface, liquid phase-solid phase interface).

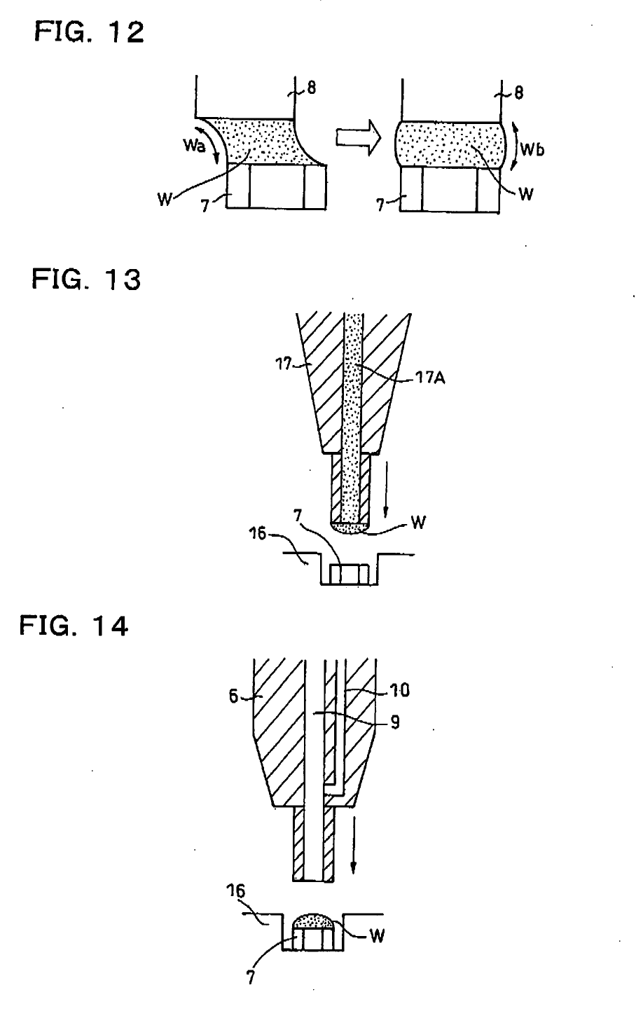

The electronic part 7 moves to the center position of the nozzle where the surface area of the liquid drop turns from Wa to the minimum surface area Wb as shown in FIG. 12. A phenomenon is referred to as a self alignment effect.

A self alignment power may be found according to the following equation. The self alignment power is compared with the dead weight of the electronic part, while a quantity capable of providing a self alignment effect is regarded as the quantity of the liquid drop of the head portion of the nozzle.

Self alignment power=γ Ln

where γ: surface tension of pure water (liquid drop)

(water: 50 [mN/m])
L: contact length (outer periphery)
n: number of electrodes in contact (number of contacts).

there is obtained a surface tension power acting on a 0402 electronic part which is a small-size electronic part having a size of 0.4 mm×0.2 mm.

When γ=50 [mN/m], L=0.4×2+0.2×2=1.2 [mm], and n=1 are substituted into the above equation, there is found 0.06 [mN] as the self alignment power.

Since the weight of each 0402 electronic part, which is a force acting on the liquid drop, is 0.000294 [mN], that is, since such weight is sufficiently small when compared with the self alignment force of the liquid, there may be used the self alignment effect of the liquid.

(2) Since the number of the suction hole to be formed in the nozzle head portion may be 1, it is possible to manufacture such a suction nozzle as has a very small head size. That is, the present embodiment may be easily attached to a very small electronic part as well.

(3) After the electronic part is attached to the suction nozzle through the pure water, the pure water is suctioned by vacuum suction to thereby suction and hold the electronic part. This may prevent the position of the electronic part from shifting from the proper position when it is moved in the XY direction.

(4) Since the pure water is used, even when the pure water is left on the electronic part and on the head portion of the suction nozzle after the pure water is suctioned by vacuum suction, such remaining pure water has no ill effect on the electronic part.

Next, description will be given below of a second embodiment of the invention with reference to FIGS. 13 and 14.

In the above-mentioned first embodiment, there is shown a case in which the mounting head 1 includes the pure water supply means and the electronic part is suctioned by the suction nozzle in a state where the pure water W is supplied through the pipe 10 to the head portion of the suction nozzle 6. On the other hand, according to the second embodiment, separately from the mounting head 1, there is provided an supply head 17 used to supply pure water and, using the supply head 17, there is attached a slight amount of pure water W from a discharge pipe 17A to the upper surface (the surface to be suctioned) of an electronic part 7 which is supplied within a part supply tape 16 to a part supply device 5.

Next, similarly to the first embodiment, the suction nozzle 6 is moved closer to the electronic part 7 and they are contacted with each other through the pure water W; and, after then, the electronic part 7 is mounted onto the substrate according to a similar operation to the first embodiment. Therefore, according to the second embodiment, instead of the structure shown in FIGS. 13 and 14, it is also possible to use an ordinary suction nozzle which does not include the pipe 10.

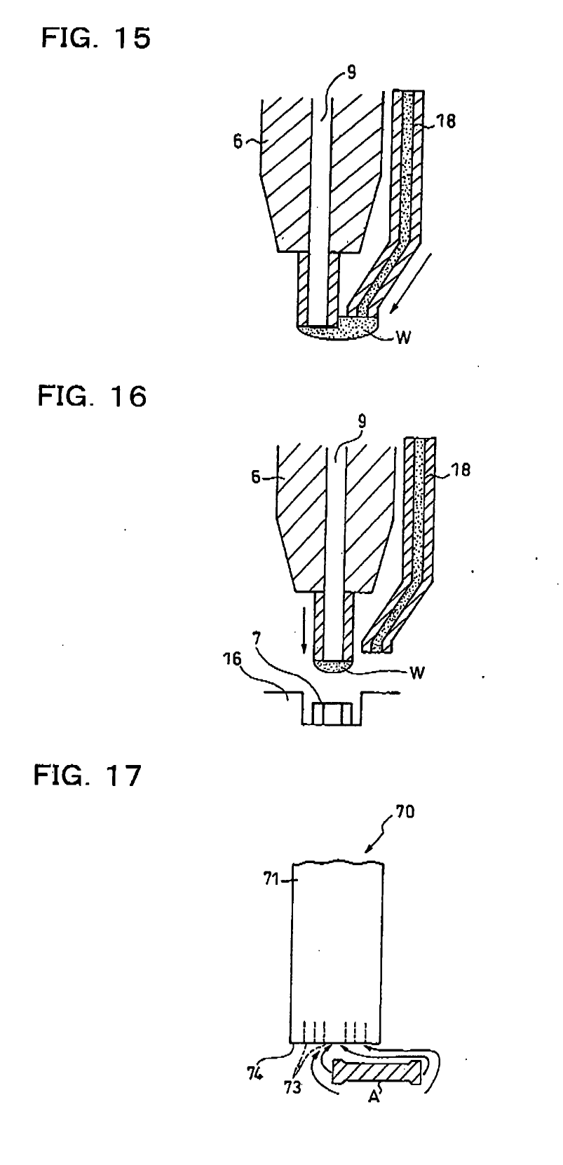

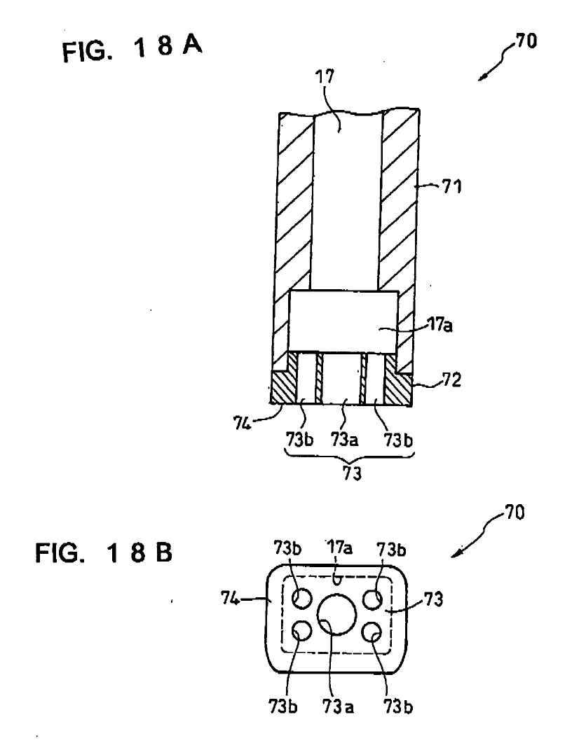

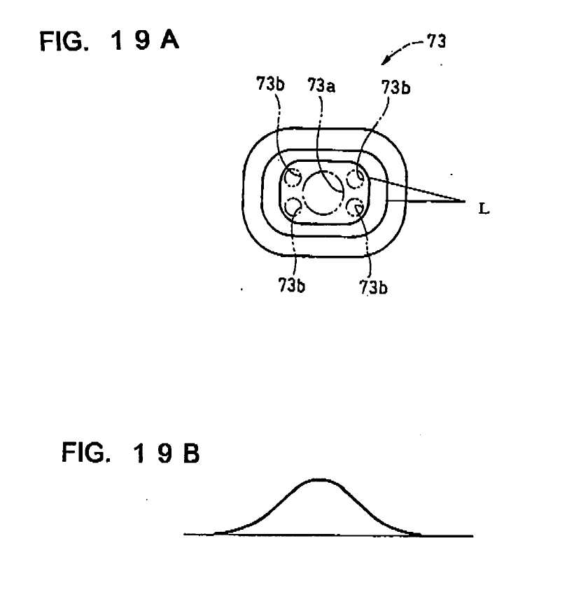

Next, description will be given below of a third embodiment of the invention with reference to FIGS. 15 and 16.

The present embodiment is similar to the first embodiment except that the pipe 10 is not provided within the suction nozzle 6 but a pure water supply nozzle 18 is disposed in the vicinity of an ordinary suction nozzle 6.

Specifically, when the mounting head 1 positioned on the part supply device 5 moves down the suction nozzle 6 in order to suction the electronic part 7, the pure water solenoid valve 15 shown in FIG. 4 is opened while keeping on the nozzle lowering operation, and the pure water W is discharged in a slight amount from the pure water supply nozzle 18 and, as shown in FIG. 15, is supplied to the head of the suction nozzle 6. And, the suction nozzle 6 is allowed to lower on until the pure water W stored on the head of the suction nozzle 6 and electronic part 7 are contacted with each other. After then, an operation to mount the electronic part 7 is carried out similarly to the first embodiment.

By the way, in the above-mentioned embodiments, there is shown an example in which pure water is used as liquid. However, as the liquid, there may also be used fluorine-system inert liquid such as chlorofluorocarbon or alcohol-system liquid such as ethanol.

According to embodiments of the invention, the electronic part is suctioned by the suction nozzle after the liquid is attached to the suction end of the suction nozzle or to the surface to be suctioned of the electronic part. Therefore, owing to the self aligning effect that is provided by the surface tension of the liquid, even an electronic part of a very small size can be positively suctioned and held by the suction nozzle in such a manner that the center of the suction end of the suction nozzle is matched to the center of the electronic part Therefore, the mounting accuracy of the electronic part can be enhanced greatly.

Since the suction power of the electronic part by the suction nozzle depends on the diameter of the liquid but not on the diameter of the suction nozzle, the need to reduce the diameter of the suction nozzle and to provide a large number of suction nozzles can be eliminated. This simplifies the working of the suction nozzle. Also, the suction nozzle is prevented from being clogged with dust. Therefore, there is less need to maintain the suction nozzle.

Also, the pure water is suctioned after the electronic part is suctioned by the pure water. Then the electronic part is suctioned and held by the vacuum air. This may prevent the position of the electronic part from being shifted during the XY direction movement thereof.

Further, since the pure water is used, even when the pure water is left on the electronic part or on the head portion of the suction nozzle after the electronic part is suctioned by the vacuum air, such remaining pure water has no ill influence on the electronic part.

What is claimed is:

1- A method of mounting an electronic part, the method comprising:
providing a liquid on a surface of the electronic part;
attaching the electronic part to a suction end of a suction nozzle via the liquid; and
mounting the electronic part onto a substrate.

2. The method according to claim 1, wherein the liquid comprises a pure water.

3. A method of mounting an electronic part, the method comprising:
providing a liquid at a suction end of a suction nozzle;
attaching the electronic part to the suction end of the suction nozzle via the liquid;
suctioning the liquid from the suction end to hold the electronic part at the suction end; and
mounting the electronic part onto a substrate.

4. The method according to claim 3, wherein the liquid comprises a pure water.

5. An apparatus for mounting an electronic part, the apparatus comprising:
a liquid supplier which provides a liquid on a surface of the electronic part; and
a suction nozzle which suctions the liquid and holds the electronic part,
wherein the suction nozzle mounts the electronic part onto a substrate.

6. The apparatus according to claim 5, wherein the liquid supplier is provided on the suction nozzle.

7. The apparatus according to claim 5, further comprising:
an air solenoid valve which controls the suction nozzle; and
a liquid solenoid valve which controls an amount of the liquid to be provided from the liquid supplier.

8. The apparatus according to claim 5, wherein the liquid comprises a pure water.
